(19) United States
(12) Patent Application Publication
(10) Pub. No.: US 2015/0145939 A1
(43) Pub. Date: May 28, 2015

(54) METHOD FOR PRODUCING A PRINT

(71) Applicant: DAI NIPPON PRINTING CO., LTD., Tokyo-to (JP)

(72) Inventors: Suguru Yabe, Tokyo-to (JP); Makoto Hashiba, Tokyo-to (JP); Katsuyuki Hirano, Tokyo-to (JP); Kozo Odamura, Tokyo-to (JP)

(73) Assignee: DAI NIPPON PRINTING CO., LTD, Toyko-to (JP)

(21) Appl. No.: 14/404,846

(22) PCT Filed: Mar. 7, 2014
(86) PCT No.: PCT/JP2014/056026

§ 371 Date: Dec. 1, 2014

(30) Foreign Application Priority Data
Mar. 19, 2013 (JP) 2013-056458

(51) Int. Cl. B41J 2/325

(52) U.S. Cl. CPC B41J 2/325
USPC 347/213

(57) ABSTRACT

The present invention is to provide a method for producing a print, which is able to prevent damages to the image-receiving sheet and generation of large wrinkles at the edges of the ink ribbon, to reduce printing unevenness, and thus to provide a high-quality print. Disclosed is a method for producing a print, in which a print is made on an image-receiving sheet by use of a specific thermal-transfer printer and an ink ribbon, wherein the ink ribbon has at least one color material layer and a protection layer; the image-receiving sheet has a receptor layer; and after printing all colors of the color material layers, the dynamic friction coefficient between the receptor layer surface of the image-receiving sheet before being coated with the protection layer and the outermost surface on the protection layer of the ink ribbon, is 0.4 or less.

### TECHNICAL FIELD

The present invention relates to a method for producing a print.

### BACKGROUND ART

A thermal-transfer printer is a conventionally-known printer in which an ink ribbon and an image-receiving sheet are sandwiched between a thermal head and a platen roller, and dyes contained in the ink ribbon are transferred to the image-receiving sheet by applying heat from the thermal head to the ink ribbon. In such a thermal-transfer printer, for separation of the ink ribbon from the image-receiving sheet after heat transfer, a separating member is arranged in the downstream of the printing position to guide the ink ribbon in a direction away from the image-receiving sheet.

In Patent Literature 1, a thermal transfer line printer containing a ribbon separating member is disclosed, in which a part, which is in the downstream of the sheet feed position, of an ink ribbon contacting part is formed in such a curved shape that the part is the most convex at the center in the width direction of the ink ribbon. According to Patent Literature 1, since the ribbon separating member is formed in the curved shape, the center in the width direction of the ink ribbon is separated earlier from a sheet, and the edges in the width direction of the ink ribbon are separated afterwards. Therefore, the first separation force acting on the area where the ribbon and the sheet are separated from each other can be small, so that the ink ribbon can be separated from the sheet, with no damage to the sheet.

In Patent Literature 2, a thermal-transfer printer is disclosed, which is equipped with a separation roller that is arranged in the downstream of the printing position established between a thermal head and a platen roller and specifies the stripping starting position of an ink ribbon, and a tension member that is arranged in the downstream far more than the separation roller and tightly stretches the ink ribbon so as to be able to slide between the printing position and the member through the separation roller, and in which the surface of the tension member facing the ink ribbon is provided so as to be in such a curved shape that the center is protruding more than the edges in the width direction. According to Patent Literature 2, the surface of the tension member facing the ink ribbon is formed in the shape that the center is protruding more than the edges in the width direction and pressed into the ink ribbon; therefore, substantially uniform feeding with respect to the width direction of the ink ribbon is carried out, thus preventing generation of wrinkles, which is due to a change in feeding rate or the presence or absence of stretching of the ink ribbon, and thus preventing generation of printing unevenness.

### CITATION LIST

Patent Literature 1: Japanese Patent Application Laid-Open (JP-A) No. 2002-144614
Patent Literature 2: JP-A No. 2009-297944

### SUMMARY OF INVENTION

### Technical Problem

The ribbon separating member of Patent Literature 1 and the tension member of Patent Literature 2 are both members which are arranged in the downstream of the printing position and apply a tension to the ink ribbon between the ribbon separating member or tension member and the printing position to tightly stretch the ink ribbon, and which have a common function in that they contributes by the tension to separation of the ink ribbon from the image-receiving sheet. Also, because the ribbon separating member or tension member is in such a shape that the center in the width direction is protruding, the tension applied to the ink ribbon is controlled in the width direction.

The inventors of the present invention have found that in the case where prints are made by use of a thermal-transfer printer equipped with a tension member which has, as a tension member that serves to apply tension to the ink ribbon, such a shape that the center is protruding more than the edges in the width direction, such as the ribbon separating member of Patent Literature 1 or the tension member of Patent Literature 2, printing unevenness may be generated intermittently in the form of perforation, near the center in the width direction.

The present invention was achieved in light of the above circumstances. An object of the present invention is to provide a method for producing a print, which is able to prevent damages to the image-receiving sheet upon separation of the ink ribbon and generation of large wrinkles at the edges of the ink ribbon upon printing, to reduce printing unevenness that is generated intermittently in the form of perforation and near the center of the print, and thus to provide a high-quality print.

### Solution to Problem

The method for producing a print of the present invention is a method for producing a print, in which a print is made on an image-receiving sheet by use of a thermal-transfer printer and an ink ribbon, wherein,

the thermal-transfer printer comprises a tension member for tightly stretching the ink ribbon in the downstream of a printing position disposed between a thermal head and a platen roller;

the surface of the tension member facing the ink ribbon has a curved shape whose center in the width direction is protruding 0.4 to 2 mm in the flow direction of the ink ribbon, more than the edges in the width direction;

the ink ribbon has at least one color material layer and a protection layer;

the image-receiving sheet has a receptor layer; and

after printing all colors of the color material layers, the dynamic friction coefficient between the receptor layer surface of the image-receiving sheet before being coated with the protection layer and the outermost surface on the protection layer of the ink ribbon, is 0.4 or less.

In the print production method of the present invention, it is preferable that a silicone oil contained in the receptor layer accounts for 0.5 to 5.0% by mass of the total solid content of the receptor layer, from the viewpoint of being less likely to generate wrinkles and being able to obtain a high-quality print.

Also, it is preferable that a polyethylene wax contained in the color material layer of the ink ribbon accounts for 0.3 to 2.0% by mass of the total solid content of the color material layer, from the viewpoint of being less likely to generate wrinkles and being able to obtain a high-quality print.

### Advantageous Effects of Invention

According to the present invention, a method for producing a print can be obtained, which is able to prevent damages to the image-receiving sheet upon separation of the ink ribbon and generation of large wrinkles at the edges of the ink ribbon upon printing, to reduce printing unevenness that is generated intermittently in the form of perforation and near the center of the print, and thus to provide a high-quality print.

### BRIEF DESCRIPTION OF DRAWINGS

FIG. 1 is a sectional view schematically showing an example of the ink ribbon used in the present invention.

FIG. 2 is a sectional view schematically showing a part of an example of the thermal-transfer printer used in the present invention.

FIG. 3 is a plan view schematically showing a part of an example of the thermal-transfer printer used in the present invention.

### DESCRIPTION OF EMBODIMENTS

Hereinafter, the method for producing a print of the present invention will be described in detail.

### [Method for Producing a Print]

The print production method of the present invention is a method for producing a print, in which a print is made on an image-receiving sheet by use of a thermal-transfer printer and an ink ribbon, wherein,

the thermal-transfer printer comprises a tension member for tightly stretching the ink ribbon in the downstream of a printing position disposed between a thermal head and a platen roller;

the surface of the tension member facing the ink ribbon has a curved shape whose center in the width direction is protruding 0.4 to 2 mm in the flow direction of the ink ribbon, more than the edges in the width direction;

the ink ribbon has at least one color material layer and a protection layer;

the image-receiving sheet has a receptor layer; and

after printing all colors of the color material layers, the dynamic friction coefficient between the receptor layer surface of the image-receiving sheet before being coated with the protection layer and the outermost surface on the protection layer of the ink ribbon, is 0.4 or less.

According to the method of the present invention, it is possible to prevent damages to the image-receiving sheet upon separation of the ink ribbon and generation of large wrinkles at the edges of the ink ribbon upon printing, to reduce printing unevenness that is generated intermittently in the form of perforation and near the center of the print, and thus to provide a high-quality print.

The mechanism that the above effects can be obtained by the production method of the present invention is not clear yet; however, it is presumed as follows.

The thermal-transfer printer equipped with the tension member which is for tightly stretching the ink ribbon in the downstream of a printing position disposed between a thermal head and a platen roller and which has a curved shape whose center in the width direction is protruding, is able to control the tension applied to the ink ribbon in the width direction, because the tension member is in the curved shape that the center in the width direction is protruding. Therefore, it is known that damages to the image-receiving sheet upon separation of the ink ribbon and wrinkles of the ink ribbon in the printing position can be prevented. As a result of diligent researches, the inventors of the present invention have found that when the length of the protrusion of the tension member is less than 0.4 mm, damages to the image-receiving sheet may not be sufficiently prevented upon separation of the ink ribbon; meanwhile, when the length is more than 2 mm, the tension applied to the center in the width direction is larger than the tension applied to the edges in the width direction, so that the ink ribbon is twisted between the center and edges in the width direction and results in large wrinkles in the edges of the ink ribbon.

On the other hand, the inventors have also found that the above problem can be solved by producing a print by use of a thermal-transfer printer equipped with a tension member has a curved shape whose center in the width direction is protruding 0.4 to 2 mm in the flow direction of the ink ribbon, more than the edges in the width direction; however, printing unevenness may be generated intermittently in the form of perforation, near the center in the width direction of the print. Such printing unevenness was not observed when the tension member does not have the curved shape, and it was observed prominently especially when the tension member has a curved shape whose center in the width direction is protruding 0.4 mm or more, more than the edges in the width direction. It is presumed that in the case of using the tension member having a curved shape, the tension near the center in the width direction of the ink ribbon is likely to be larger than the edges in the width direction and, in the printing position, the vicinity of the center in the width direction of the ink ribbon is relatively strongly stretched, so that a part of the vicinity of the center is twisted and results in the above-mentioned printing unevenness.

The inventors have found that this new problem can be solved by selecting and combining the ink ribbon and the image-receiving sheet so that the dynamic friction coefficient between the ink ribbon and the image-receiving sheet is smaller than a predetermined value.

In the print production method of the present invention, the ink ribbon having at least one color material layer and a protection layer is used in combination with the image-receiving sheet having a receptor layer; moreover, the dynamic friction coefficient between the receptor layer surface of the image-receiving sheet before being coated with a protection layer and the outermost surface on the protection layer of the ink ribbon, is 0.4 or less. Therefore, the friction force generated between the ink ribbon and the image-receiving sheet is lowered and results in an increase in slidability therebetween. Therefore, when the tension applied to one edge of the ink ribbon differs from the tension applied to the other edge of the same, it is presumed that in the area where the tension is relatively large and a twist is thus generated, a slide occurs between the ink ribbon and the image-receiving sheet and eases the twist. As a result, it is presumed that a twist is less likely to occur in the width direction of the ink ribbon, and the above-mentioned intermittent printing unevenness in the form of perforation is less likely to occur. On the other hand, it is presumed that in the area where the tension is relatively large and no slide occurs between the ink ribbon and the image-receiving sheet, the twist thus generated is less likely to be released and, as a result, the intermittent printing unevenness in the form of perforation occurs.

In the present invention, after printing all colors of the color material layers in colors, the dynamic friction coefficient between the receptor layer surface of the image-receiving sheet before being coated with a protection layer and the outermost surface on the protection layer of the ink ribbon becomes the highest. Therefore, when the dynamic friction coefficient is 0.4 or less, the dynamic friction coefficient between, for example, the surface of the image-receiving layer and the surface of the color material layer of the ink ribbon is 0.4 or less before printing.

Therefore, in the case where, after printing all colors of the color material layers in colors, the dynamic friction coefficient between the receptor layer surface of the image-receiving sheet before being coated with a protection layer and the outermost surface on the protection layer of the ink ribbon is 0.4 or less all over the area where the ink ribbon is in contact with the image-receiving sheet, so that the intermittent printing unevenness in the form of perforation does not occur.

The outermost surface on the protection layer means the outermost surface on the side to be in contact with the receptor layer, in the region of the protection layers sequentially disposed side by side on the ink ribbon. When other layers are not disposed on the protection layer, the outermost surface means the surface of the protection layer. When other layers such as an adhesion layer are disposed on the protection layer, the outermost surface means the surface of the outermost layer of other layers disposed on the protection layer.

### <Dynamic Friction Coefficient>

In the present invention, a value obtained by the following method is used as the dynamic friction coefficient.

First, an image-receiving sheet and ink ribbon to be evaluated are prepared. Next, the color material layers of the ink ribbon are printed all over the receptor layer of the image-receiving sheet, using a known thermal-transfer printer, thereby obtaining the image-receiving sheet before being coated with the protection layer. The receptor layer surface of the thus-obtained image-receiving sheet before being coated with the protection layer, is brought into contact with a surface of the ink ribbon, which is the surface on the side to be brought into contact with the receptor layer upon transfer of the protection layer of the ink ribbon. After placing a 1 kg weight on the stack, the stack is placed in the environment of a temperature of 25° C. and a humidity of 50% and measured for the tension (g) when the ink ribbon is pulled in the longitudinal direction so as to have an ink ribbon movement rate of 200 mm/min. Then, the dynamic friction coefficient is calculated from the value of the tension. As the measurement system, a surface property tester (“TriboGear” (type: 14DR) manufactured by Shinto Scientific Co., Ltd.) can be used.

In the present invention, the unit of movement distance “mm/min” means a movement distance (mm) per minute.

In the present invention, because the above-measured dynamic friction coefficient between the receptor layer surface of the image-receiving sheet before being coated with a protection layer and the outermost surface on the protection layer of the ink ribbon, is 0.4 or less, intermittent printing unevenness in the form of perforation is not generated. Also, it is preferable that the dynamic friction coefficient between the receptor layer surface of the image-receiving sheet before being coated with a protection layer and the outermost surface on the protection layer of the ink ribbon is 0.2 or more and 0.4 or less. When the dynamic friction coefficient is 0.2 or more, a slide is less likely to occur between the ink ribbon and the image-receiving sheet, which are stacked before the printing position, and generation of wrinkles due to the slide is prevented in the printing position.

### <Ink Ribbon>

The ink ribbon used in the present invention has at least one color material layer and a protection layer. In general, the color material layer and the protection layer are disposed on the substrate. The ink ribbon can have other optional layer(s), within a scope which does not impair the effects of the present invention.

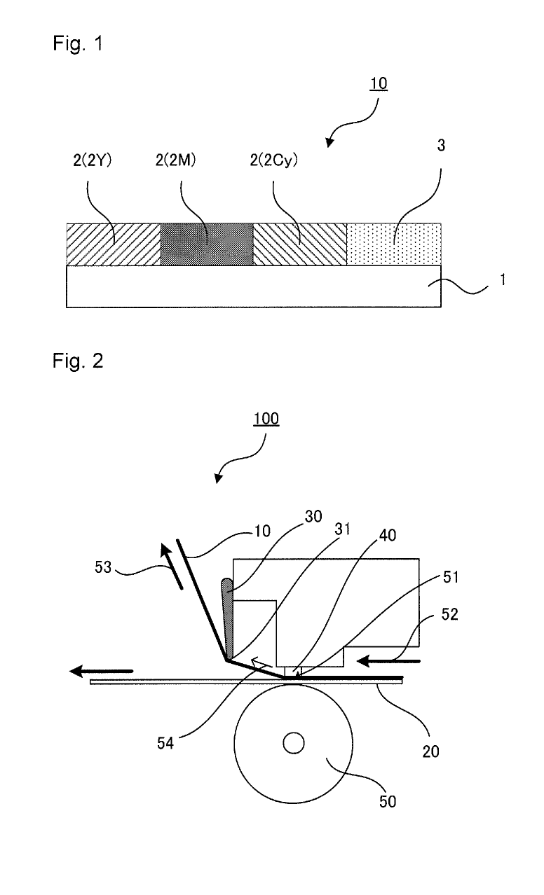

FIG. 1 is a sectional view schematically showing an example of the ink ribbon used in the present invention. An ink ribbon 10 of the present invention generally contains a substrate 1. On one surface of the substrate 1, color material layers 2 and a separable protection layer 3 are disposed sequentially side by side. In FIG. 1, the color material layers 2 in three colors of yellow, magenta and cyan (color material layers 2Y, 2M and 2Cy) are disposed sequentially side by side.

### (Substrate)

The substrate is generally used to retain the color material layers and the protection layer. The material for the substrate is not particularly limited and can be appropriately selected from those that are used in ink ribbon applications. Concrete examples of the substrate include films and sheets of plastics such as polyesters including polyethylene terephthalate, polyarylates, polycarbonates, polyurethanes, polyimides, polyetherimides, cellulose derivatives, polyethylenes, ethylene-vinyl acetate copolymers, polypropylenes, polystyrenes, acryls, polyvinyl chlorides, polyvinylidene chlorides, polyvinyl alcohols, polyvinyl butyrals, nylons, polyether ether ketones, polysulfones, polyethersulfones, tetrafluoroethylene-perfluoroalkyl vinyl ethers, polyvinyl fluorides, tetrafluoroethylene-ethylenes, tetrafluoroethylene-hexafluoropropylenes, polychlorotrifluoroethylenes and polyvinylidene fluorides. The thickness of the substrate can be appropriately determined depending on the material so as to have an appropriate strength and heat resistance. It is generally about 2.5 μm to 100 μm.

To increase adhesion to adjacent layers, the substrate can be subjected to a surface treatment. Examples of the surface treatment include known resin surface modifying techniques such as a corona discharge treatment, a flame treatment, an ozone treatment, a UV treatment, a radiation treatment, a surface roughening treatment, a chemical treatment, a plasma treatment, and a grafting treatment. Of them, as the surface treatment, one kind of surface treatment can be carried out, or two or more kinds of surface treatments can be carried out.

### (Color Material Layer)

In the present invention, the ink ribbon has at least one color material layer. It can be a layer in an appropriately selected one color. In the case where a full color image is demanded, the ink ribbon can contain color material layers in three colors of cyan, magenta and yellow can be used. As needed, the ink ribbon can further contain a color material layer in black.

In the present invention, the color material layer generally contains a color material and a binder resin for supporting the color material. It can further contain other component(s) within a scope which does not impair the effects of the present invention. Hereinafter, the components of the color material layer will be described in order.

### (1) Color Material

The color material used for the color material layer can be appropriately selected, depending on the intended use. For example, in the case of obtaining a sublimation ink ribbon, the color material layer is a color material layer containing a sublimation dye. In the case of obtaining a heat-meltable ink ribbon, the color material layer is a color material layer containing a pigment with excellent heat resistance, etc. From the viewpoint of being able to control the transfer amount of the color material and to control density gradation and being excellent in sharpness and transparency, it is particularly preferable to use a sublimation dye.

The sublimation dye can be appropriately selected from conventionally-known sublimation dyes. Concrete examples of the sublimation dye include: diarylmethane-based dyes; triarylmethane-based dyes; thiazole-based dyes; melocyanine dyes; pyrazolone dyes; methine-based dyes; indoaniline-based dyes; azomethine-based dyes such as acetophenoneazomethine, pyrazoloazomethine, imidazoleazomethine, imidazoazomethine and pyridoneazomethine; xanthene-based dyes; oxazine-based dyes; cyanostyrene-based dyes such as dicyanostyrene and tricyanostyrene; thiazine-based dyes; azine-based dyes; acridine-based dyes; benzene azo-based dyes; azo-based dyes such as pyridone azo, thiophene azo, isothiazole azo, pyrrole azo, pyrazole azo, imidazole azo, thiadiazole azo, triazole azo and disazo; spiropyran-based dyes; indolinospiropyran-based dyes; fluoran-based dyes; rhodamine lactam-based dyes; naphthoquinone-based dyes; anthraquinone-based dyes; and quinophthalone-based dyes. More specifically, there may be mentioned compounds disclosed in Japanese Patent Application Laid-Open (JP-A) No. H07-149062.

In the color material layer containing the sublimation dye, the content of the sublimation dye accounts for preferably 5 to 90% by mass, more preferably 20 to 80% by mass of the total solid content of the color material layer. When the content is equal to or less than the lower limit, the color material layer has excellent printing density. When the content is equal to or more than the upper limit, the color material layer has excellent storage stability.

### (2) Binder Resin

In the present invention, to support the color material, the color material layer generally contains a binder resin. As the binder resin, one with heat resistance and appropriate affinity for dye is preferably used. Concrete examples of such a binder resin include cellulose-based resins such as ethyl cellulose, hydroxyethyl cellulose, ethylhydroxy cellulose, hydroxypropyl cellulose, methyl cellulose, cellulose acetate and cellulose butyrate; vinyl-based resins such as polyvinyl alcohol, polyvinyl acetate, polyvinyl butyral, polyvinyl acetoacetal and polyvinylpyrrolidone; acrylic resins such as poly(meth) acrylate and poly(meth)acrylamide; polyurethane-based resins; polyamide-based resins; and polyester-based resins. Of these binder resins, from the viewpoint of being excellent in heat resistance and dye transferability, preferred are cellulose-based resins, vinyl-based resins, acryl-based resins, urethane-based resins and polyester-based resins. More preferred are vinyl-based resins. Of vinyl-based resins, particularly preferred are polyvinyl butyral and polyvinyl acetoacetal.

### (3) Other Component(s)

As needed, the color material layer can contain a conventionally-known additive(s) such as a release agent, inorganic fine particles, organic fine particles, etc. In the present invention, it is particularly preferable to add a release agent, from the viewpoint of being able to decrease the dynamic friction coefficient.

Concrete examples of the release agent include solid waxes such as a polyethylene wax, an amide wax and a Teflon (trade name) powder; fluorine-based or phosphoric acid ester-based surfactants; silicone oil; and various kinds of silicone resins.

The silicone oil can be a non-modified silicone oil or a modified silicone oil. Examples of the modified silicone oil include a reactive silicone oil and a non-reactive silicone oil. Preferred is a curable reactive silicone oil. Concrete examples of the reactive silicone oil include various kinds of modified silicone oils such as an amino-modified silicone oil, an epoxy-modified silicone oil, a carboxyl-modified silicone oil, a carbinol-modified silicone oil, a methacryl-modified silicone oil, a mercapto-modified silicone oil, a phenol-modified silicone oil, a single terminal reactive silicone oil, and a different functional groups-modified silicone oil. Concrete examples of the non-reactive silicone oil include various kinds of modified silicone oils such as a polyether-modified silicone oil, a methylstyryl-modified silicone oil, an alkyl-modified silicone oil, a higher fatty acid ester-modified silicone oil, a hydrophilic specially-modified silicone oil, a higher alkoxy-modified silicone oil, a higher fatty acid-modified silicone oil, and a fluorine-modified-modified silicone oil. There silicone oils can be used alone or in combination of two or more kinds.

Also, the color material layer preferably contains the polyethylene wax. By containing the polyethylene wax, the dynamic friction coefficient can be easily decreased, and the abrasion resistance of the thus-obtained print can be increased.

As the polyethylene wax, it is preferable to use polyethylene wax particles having a density of 0.94 to 0.97 g/cm³ (a finely powdered polyethylene wax). In the case of using the polyethylene wax particles, the particle diameter is preferably such that the average particle diameter is 15 μm or less, particularly preferably 7 to 12 μm. The form of the polyethylene wax particles can be a spherical form, an angular form, a columnar form, a needle form, a plate form, an irregular form, etc. In the present invention, from the viewpoint of being able to easily decrease the dynamic friction coefficient, the polyethylene wax particles are preferably in a spherical form.

As the polyethylene wax, a polyethylene wax having a number average molecular weight (Mn) of 2,000 or more and 3,000 or less is preferred.

In the present invention, from the viewpoint of being able to easily decrease the dynamic friction coefficient, it is particularly preferable that the color material layer contains one or more kinds selected from a silicone oil and a polyethylene wax. When the color material layer contains a silicone oil or a polyethylene wax, the slidability between the receptor layer and the color material layer of the ink ribbon is good, and the silicone oil or the polyethylene wax transfers to the surface of the receptor layer of the image-receiving sheet upon printing. Therefore, the dynamic friction coefficient between the receptor layer and the protection layer is less likely to increase after printing. When the color material layer contains one or more kinds selected from a silicone oil and a polyethylene wax, the content can be appropriately determined so that the dynamic friction coefficient is equal to or smaller than the predetermined value.

When the color material layer contains a silicone oil, the content of the silicone oil in the color material layer preferably accounts for 0.5 to 3.0% by mass, more preferably 1.0 to 2.0% by mass of the total solid content of the color material layer. When the content of the silicone oil is equal to or more than the lower limit, the color material layer is highly effective in preventing an increase in the dynamic friction coefficient. When the content is equal to or less than the upper limit, the thus-obtained print is excellent in printing sensitivity.

When the color material layer contains a polyethylene wax, the content of the polyethylene wax in the color material layer preferably accounts for 0.3 to 2.0% by mass, more preferably 0.5 to 1.5% by mass of the total solid content of the color material layer. When the content of the polyethylene wax is equal to or more than the lower limit, the color material layer is less likely to increase the dynamic friction coefficient and is excellent in abrasion resistance. When the content is equal to or less than the upper limit, the thus-obtained print is excellent in printing sensitivity.

The color material layer can be formed as follows: the color material, the binder resin and, as needed, an additive(s) are dissolved or dispersed in a solvent to produce a coating solution; the coating solution is applied onto the substrate by a known method such as a gravure printing method, a screen printing method, or a reverse roll coating method using a gravure printing plate; then, the applied solution is dried, thereby obtaining the color material layer.

The thickness of the color material layer is not particularly limited. It is generally 0.1 to 5.0 μm, particularly preferably 0.5 to 2.0 μm.

### (Protection Layer)

The protection layer is a layer that is used to protect the surface of the print after printing, and it is a layer that covers the image-receiving sheet after printing.

The protection layer is made of a transparent resin, and it can be appropriately selected from resins with excellent abrasion resistance, chemical resistance, hardness, etc. Examples thereof include a polyester resin, a polystyrene resin, an acrylic resin, a polyurethane resin, an acrylic urethane resin, a cellulose ester resin, silicone-modified resins thereof, and mixtures thereof.

Also, highly transparent particles such as silica, alumina, calcium carbonate, plastic pigments, etc., or waxes such as a polyethylene wax, can be added to the resin.

From the viewpoint of plasticizer resistance, as the resin, the protection layer preferably contains one or more kinds selected from a cellulose ester having a number average molecular weight (Mn) of 15,000 or more and 30,000 or less and a vinyl chloride-vinyl acetate copolymer having a number average molecular weight (Mn) of 15,000 or more and 30,000 or less. Also from the viewpoint of dyeing properties and releasability, the protection layer more preferably contains a cellulose ester having a number average molecular weight (Mn) of 15,000 or more and 30,000 or less.

A cellulose ester is a compound obtained by esterifying a part or the whole of a cellulose. Examples thereof include cellulose acetate, cellulose propionate (CAP) and cellulose butyrate (CAB).

In the present invention, “number average molecular weight” is a polystyrene equivalent value obtained by gel permeation chromatography (GPC).

The protection layer is also required to have a function which allows to make a print further on a print on which the protection layer has been transferred. From the viewpoint of dyeing properties and releasability at that time, the protection layer preferably contains a cellulose ester having a number average molecular weight (Mn) of 7,000 or less.

As the resin used for the protection layer, from the viewpoint of plasticizer resistance, dyeing properties and releasability, it is particularly preferable to use a mixture of (A) one or more kinds selected from a cellulose ester having a number average molecular weight (Mn) of 15,000 or more and 30,000 or less and a vinyl chloride-vinyl acetate copolymer having a number average molecular weight (Mn) of 15,000 or more and 30,000 or less, and (B) a cellulose ester having a number average molecular weight (Mn) of 7,000 or less.

In the case of using a mixture of the (A) component and the (B) component as the resin used for the protection layer, from the viewpoint of dyeing properties, releasability and plasticizer resistance, it is preferable that the total content of the (A) component and the (B) component accounts for 70% by mass or more of the total solid content of the protection layer.

It is preferable that the protection layer further contains a polyethylene wax. By containing a polyethylene wax, the dynamic friction coefficient can be easily decreased, and excellent abrasion resistance is provided to the thus-obtained print. As the polyethylene wax, a polyethylene wax having a number average molecular weight (Mn) of 2,000 or more and 3,000 or less is preferably used.

The content of the polyethylene wax in the protection layer is not particularly limited. From the viewpoint of decreasing the dynamic friction coefficient and being excellent in abrasion resistance, the content of the polyethylene wax preferably accounts for 1 to 10% by mass of the total solid content of the protection layer.

From the viewpoint of being excellent in releasability and abrasion resistance, the protection layer can further contain a fluorine resin.

The fluorine resin can be appropriately selected from conventionally known fluorine resins. Examples thereof include a polyvinylidene fluoride, a tetrafluoroethylene resin, a tetrafluoroethylene perfluoroalkoxy vinyl ether copolymer, a tetrafluoroethylene-hexafluoropropylene copolymer, a polychlorotrifluoroethylene, a tetrafluoroethylene-ethylene copolymer, a chlorotrifluoroethylene-ethylene copolymer, and a polyvinylfluoride (PVF).

The content of the fluorine resin in the protection layer preferably accounts for 0.5 to 3% by mass of the total solid content of the protection layer.

The protection layer can be formed as follows: the resin and, as needed, the polyethylene wax and/or the fluorine resin are dissolved or dispersed in a solvent to produce a coating solution; the coating solution is applied onto the substrate by a known method such as a gravure printing method, a screen printing method, or a reverse roll coating method using a gravure printing plate; then, the applied solution is dried, thereby obtaining the protection layer.

The thickness of the protection layer is not particularly limited. It is generally 0.5 to 10 μm, particularly preferably 1 to 5 μm.

### <Other Layers>

The ink ribbon used in the present invention can further contain other layers such as a release layer, a rear layer and an adhesive layer. The ink ribbon can be various kinds of embodiments, to the extent which does not impair the scope of the present invention.

### (Release Layer)

In the ink ribbon used in the present invention, to increase transferability, a release layer can be disposed between the substrate and the color material layer or protection layer. Examples of the resin for forming the release layer include waxes, a silicone wax, a silicone-modified resin, a fluorine resin, a fluorine-modified resin, a polyvinyl alcohol, an acrylic resin, a thermally-crosslinking epoxy-amino resin, and a thermally-crosslinking alkyd-amino resin. The release layer can be made of one kind of resin or two or more kinds of resins. Also, the release layer can be formed by using a resin having releasability in combination with a crosslinking agent (e.g., an isocyanate compound) and/or a catalyst (e.g., a tin-based catalyst, an aluminum-based catalyst). The thickness of the release layer is generally about 0.5 μm to 5 μm.

### (Rear Layer)

To increase heat resistance and to increase running properties of the thermal head upon printing, a rear layer can be disposed on a surface of the substrate, which is different from the surface on which the color material layer and the protection layer are disposed.

The rear layer can be formed by appropriately selecting one from conventionally-known thermoplastic resins, etc. Examples of such thermoplastic resins include polyolefin-based resins such as a polyester-based resin, a polyacrylic acid ester-based resin, a polyvinyl acetate-based resin, a styreneacrylate-based resin, a polyurethane-based resin, a polyethylene-based resin, and a polypropylene-based resin; thermoplastic resins including polyvinyl acetal resins such as a polystyrene-based resin, a polyvinyl chloride-based resin, a polyether-based resin, a polyamide-based resin, a polyimide-based resin, a polyamideimide-based resin, a polycarbonate-based resin, a polyacrylamide resin, a polyvinylchloride resin, a polyvinyl butyral resin, and a polyvinyl acetoacetal resin, and silicone-modified products thereof. From the viewpoint of heat resistance, a polyamideimide-based resin or a silicone-modified product thereof can be preferably used.

To increase slidability, it is preferable that in addition to the thermoplastic resin, the rear layer further contains various kinds of additives including a release agent (such as a wax, a higher fatty acid amide, a phosphoric acid ester compound, a metallic soap, a silicone oil or a surfactant), an organic powder (such as a fluorine resin powder) and inorganic fine particles (such as silica, clay, talc or calcium carbonate). It is particularly preferable that the rear layer further contains at least one of a phosphoric acid ester and a metallic soap.

### (Adhesive Layer)

To increase adhesion to the receptor layer of the image-receiving sheet, an adhesive layer can be disposed on the protection layer.

The binder resin that constitutes the adhesive layer can be appropriately selected from conventionally-known binder resins that are used to form the adhesive layer. Concrete examples of the binder resins include a known thermosensitive adhesive, an acrylic resin, a vinyl chloride-vinyl acetate copolymer resin, an epoxy resin, a polyester resin, a polycarbonate resin, a butyral resin, a polyamide resin, and a vinyl chloride resin.

In addition to the binder resin, as needed, the adhesive layer can further contain additives such as a UV absorber, an antioxidant, a fluorescent whitening agent, an inorganic or organic filler component, a surfactant and a release agent.

The adhesive layer can be formed as follows: the binder resin and, as needed, the above additive(s) are dissolved or dispersed in a solvent to produce a coating solution; the coating solution is applied onto the substrate by a known method such as a gravure printing method, a screen printing method, or a reverse roll coating method using a gravure printing plate; then, the applied solution is dried, thereby obtaining the adhesive layer.

### <Image-Receiving Sheet>

The image-receiving sheet used in the present invention contains at least a receptor layer that receives the color material. The receptor layer is generally disposed on the substrate. The image-receiving sheet can further have an optional layer, within a scope which does not impair the effects of the present invention.

### (Substrate)

The material for the substrate used for the image-receiving sheet is not particularly limited. It can be selected from conventionally-known materials used in image-receiving sheet applications. Concrete examples of substrate include a condenser paper, a glassine paper, a parchment paper, a synthetic paper (such as a polyolefin-based or polystyrene-based synthetic paper), a wood free paper, an art paper, a coated paper, a cast-coated paper, a wall paper, a backing paper, a synthetic resin- or emulsion-impregnated paper, a synthetic rubber latex-impregnated paper, a synthetic resin-addition paper, a paperboard, a cellulose fiber paper, a resin-coated paper which is obtained by coating both surfaces of a cellulose paper with polyethylene and is used as a substrate of a printing paper for silver halide photography, and films or sheets of various kinds of plastics such as polyester, polyacrylate, polycarbonate, polyurethane, polyimide, polyetherimide, cellulose derivative, polyethylene, ethylene-vinyl acetate copolymers, polypropylene, polystyrene, acryl, polyvinyl chloride and polyvinylidene chloride. Also, these synthetic resins can be mixed with a white pigment or filler and formed into a film in which microvoids are present inside the substrate (i.e., a porous film).

As the substrate, there may be also used a laminate obtained by optionally combining the above-mentioned materials. Examples of typical laminates include a combination of a cellulose fiber paper and a synthetic paper, and a synthetic paper obtained by laminating a cellulose fiber paper and a plastic film or sheet. Such a laminated synthetic paper can be a laminate of two layers. To provide substrate texture or feeling, it can be a laminate of three or more layers obtained by attaching a synthetic paper, plastic film or porous film to both surfaces of a cellulose fiber paper (used as a core). Also, it can be a laminate with thermal insulation properties, which is obtained by forming a resin layer, in which hollow particles are dispersed, on a surface of a coated paper, resin-coated paper or plastic film by coating.

The method for attaching the laminate can be any method, such as dry lamination, wet lamination or extrusion lamination. The method for laminating a hollow particle layer as mentioned above can be, but not limited to, a coating method such as a gravure coating method, a comma coating method, a blade coating method, a die coating method, a slide coating method or a curtain coating method.

To increase the adhesion to a layer to be formed thereon, the substrate can be one which is obtained by carrying out a primer treatment or corona discharge treatment on the surface. In the case of forming a hollow particle layer, from the viewpoint of adhesion or production efficiency, it is preferable to form the hollow particle layer by coating, such as a slide coating method or curtain coating method, at the same time as the receptor layer or other layers.

The thickness of the substrate can be appropriately determined. It is generally about 10 to 300 μm.

### (Receptor Layer)

The receptor layer used in the image-receiving sheet is a layer for accepting the color material transferred from the color material layer of the ink ribbon and maintaining the image thus formed. As the resin for forming the receptor layer, there may be mentioned a polycarbonate-based resin, a polyester-based resin, a polyamide-based resin, an acryl-based resin, an acryl-styrene-based resin, a cellulose-based resin, a polysulfone-based resin, a polyvinyl chloride resin, a vinyl chloride-acryl-based resin, a polyvinyl acetate resin, a vinyl chloride-vinyl acetate copolymer resin, a polyvinyl acetal resin, a polyvinyl butyral resin, a polyurethane-based resin, a polystyrene-based resin, a polypropylene-based resin, a polyethylene-based resin, an ethylene-vinyl acetate copolymer resin, an epoxy resin, a polyvinyl alcohol resin, gelatin and derivatives thereof. These resin materials can be used alone or in combination of two or more kinds.

From the viewpoint of being able to form an image with high glossiness and environment-friendly, a water-soluble resin or an aqueous resin is appropriately used. Concrete examples of the water-soluble resin include polyvinylpyrrolidone, polyvinyl alcohol, hydroxyethyl cellulose, carboxymethyl cellulose, phenolic resin; water-soluble acrylic resins such as polyacrylic acid, polyacrylic acid ester, polyacrylic acid ester copolymers and polymethacrylic acid; gelatin, starch, casein and modified products thereof. Concrete examples of the aqueous resin include vinyl chloride-based resin emulsions such as a vinyl chloride resin emulsion, a vinyl chloride-vinyl acetate resin emulsion and a vinyl chloride-acryl resin emulsion, acryl-based resin emulsions, urethane-based resin emulsions, vinyl chloride-based resin dispersions, acryl-based resin dispersions and urethane-based resin dispersions. There aqueous resins can be prepared by, for example, dispersing a solution containing a solvent-based resin with a homogenizer.

In the present invention, from the viewpoint of decreasing the dynamic friction coefficient, it is preferable that the receptor layer further contains a release agent, and it is more preferable that the receptor layer further contains a silicone oil. As the release agent and the silicone oil, there may be used those described above under “Color material layer”.

The content of the silicone oil is not particularly limited. From the viewpoint of being able to easily adjust the dynamic friction coefficient to the predetermined value, the content preferably accounts for 0.5 to 5.0% by mass, more preferably 1.0 to 3.0% by mass of the total solid content of the receptor layer.

The receptor layer can be formed as follows: the resin is dissolved or dispersed in an appropriate solvent to produce a coating solution; the coating solution is applied to a surface of the substrate to form a coating film; the coating film is dried, thereby obtaining the receptor layer.

The thickness of the receptor layer can be appropriately determined. It is generally 1 to 10 μm, particularly preferably 1 to 5 μm.

To impart adhesion between the receptor layer and the substrate, whiteness, cushioning properties, shielding properties, antistatic properties, anti-curling properties, etc., various kinds of conventionally-known intermediate layers can be disposed between the substrate layer and the receptor layer. Examples of binder resins used for the intermediate resins include a polyurethane-based resin, a polyester-based resin, a polycarbonate-based resin, a polyamide-based resin, an acryl-based resin, a polystyrene-based resin, a polysulfone-based resin, a polyvinyl chloride resin, a polyvinyl acetate resin, a vinyl chloride-vinyl acetate copolymer resin, a polyvinyl acetal resin, a polyvinyl butyral resin, a polyvinyl alcohol resin, an epoxy resin, a cellulose-based resin, an ethylene-vinyl acetate copolymer resin, a polyethylene-based resin, and a polypropylene-based resin. Of them, those having an active hydroxyl group can be used as the binder by being formed into isocyanate-cured products.

To impart whiteness and shielding properties to the intermediate layers, it is preferable to add a filler such as titanium oxide, zinc oxide, magnesium carbonate or calcium carbonate. In addition, to increase whiteness, a stilbene-based compound, a benzimidazole-based compound or a benzoxazole-based compound can be added as a fluorescent whitening agent. To increase light resistance of the print, a hindered amine-based compound, a hindered phenol-based compound, a benzotriazole-based compound or a benzophenone-based compound can be added as a UV absorber or antioxidant. To impart antistatic properties, a cation-based acrylic resin, a polyaniline resin or various kinds of electroconductive fillers can be added. The amount of the coated intermediate layers is preferably about 0.5 to 30 g/m² in a dried state.

### <Thermal-Transfer Printer>

The thermal-transfer printer used in the print production method of the present invention is such a thermal-transfer printer that it contains the tension member for tightly stretching the ink ribbon in the downstream of the printing position disposed between the thermal head and the platen roller, and the surface of the tension member facing the ink ribbon has a curved shape whose center in the width direction is protruding 0.4 to 2 mm in the flow direction of the ink ribbon, more than the edges in the width direction.

In the present invention, the surface of the tension member facing the ink ribbon has a curved shape whose center in the width direction is protruding 0.4 to 2 mm in the flow direction of the ink ribbon, more than the edges in the width direction. Even though the tension member has the above-specified shape, the print production method of the present invention can tightly stretch the ink ribbon between the printing position and the tension member, without generating intermittent printing unevenness in the form of perforation. Therefore, the print production method of the present invention can provide a high-quality print with no printing unevenness or wrinkles.

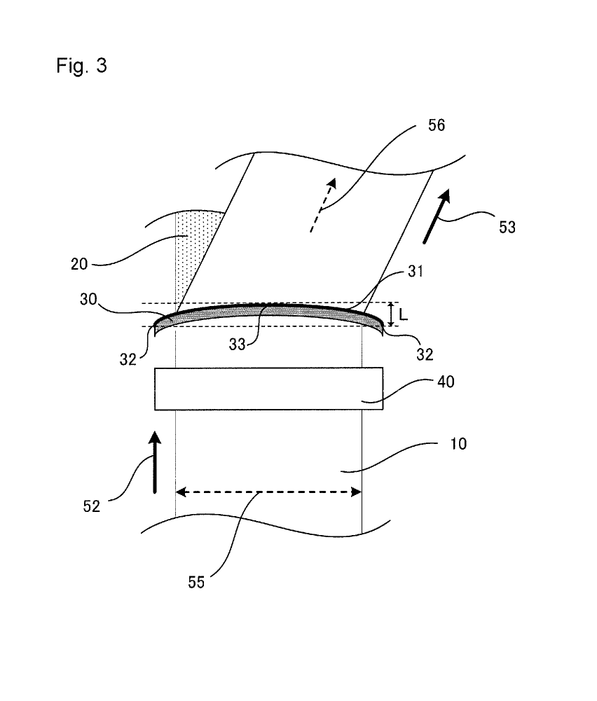

FIG. 2 is a sectional view schematically showing a part of an example of the thermal-transfer printer used in the present invention. FIG. 3 is a plan view schematically showing a part of an example of the thermal-transfer printer used in the present invention. In a thermal-transfer printer 100 used in the present invention, an ink ribbon 10 and an image-receiving sheet 20 are fed to a printing position 51 in a laminated state, the position being disposed between a thermal head 40 and a platen roller 50. By heating with the thermal head 40, the color material(s) is transferred from the ink ribbon 10 to the image-receiving sheet 20, thereby producing a print. After printing, the ink ribbon 10 is wound on a wind-up roller (53) through an ink ribbon facing surface 31 of a tension member 30, which is in the downstream of the printing position 51. At this time, a tension is generated in (applied to) the ink ribbon 10 between the tension member 30 and the printing position 51. A direction 54 of the tension in the ink ribbon printing position is not parallel to a feeding direction 52 (ink ribbon feeding direction), so that the ink ribbon 10 is separated from the image-receiving sheet 20. As shown in FIG. 3, in the tension member 30, the ink ribbon facing surface 31 has a curved shape that a center 33 in the width direction is protruding in a flow direction 56 of the ink ribbon (an ink ribbon winding direction 53) and a protruding length L thereof is 0.4 to 2 mm. Therefore, the tension applied to the center in a width direction 55 of the ink ribbon, which is likely to have relatively small tension, is increased to generate a uniform tension across the full width (direction) of the ink ribbon. Therefore, no damage is caused to the image-receiving sheet upon printing, and large wrinkles are less likely to be generated in the ink ribbon edges upon printing. Also in the present invention, by selecting and combining the image-receiving sheet and the ink ribbon so as to have the above-specified dynamic friction coefficient, intermittent printing unevenness in the form of perforation is not generated near the center of the print, and a high-quality printing can be obtained.

### (Tension Member)

In the present invention, the tension member is disposed in the downstream of the printing position and disposed in the position where to tightly stretch the ink ribbon between the tension member and the printing position. When no separating member such as a separating roller is used between the printing position and the tension member, the tension member functions as a member for separating the image-receiving sheet and the ink ribbon from each other. In the case of using a separating member, the tension member also contributes to the separation.

In the tension member used in the present invention, the ink ribbon facing surface has a curved shape whose center in the width direction is protruding 0.4 to 2 mm in the flow direction of the ink ribbon, more than the edges in the width direction. The curved shape whose center in the width direction is protruding in the flow direction of the ink ribbon more than the edges in the width direction, means that the vicinity of a center 35 in the width direction is located in the downstream of the flow direction 56 of the ink ribbon, compared to a straight line between the two edges 32 in the width direction of the ink ribbon facing surface 31 of the tension member. The surface of the tension member facing the ink ribbon is preferably in such a shape that the whole surface is gently curved and the center in the width direction is most protruding. The protruding length L indicates a distance between the straight line (between the two edges 32 in the width direction of the ink ribbon facing surface 31 of the tension member) and the position of the most protruding part of the center 33 of the ink ribbon facing surface (see FIG. 3). In general, the straight line between the two edges in the width direction is arranged so as to be perpendicular to the flow direction 56 of the ink ribbon.

In the present invention, by using the tension member having a protruding length L of 0.4 to 2 mm, no damage is caused to the image-receiving sheet; wrinkles are less likely to be generated in the ink ribbon upon printing; and large printing unevenness is prevented.

In the present invention, the tension member can be a block-shaped member which is thicker in the flow direction of the ink ribbon. From the viewpoint of being able to freely control the degree of curve, the tension member is preferably a curved plate-shaped member.

Components other than the tension member, such as the thermal head and platen roller of the thermal-transfer printer, can be appropriately selected from conventionally-known components. In particular, for example, there may be mentioned one obtained by combining the tension member in which the ink ribbon facing surface has a curved shape whose center in the width direction is protruding 0.4 to 2 mm more than the edges in the width direction, with a thermal-transfer line printer disclosed in JP-A No. 2002-144614 or a thermal-transfer printer disclosed in JP-A No. 2009-297044, which is equipped with a separation roller.

In the print production method of the present invention, the combination of the ink ribbon and the image-receiving sheet, the combination having been confirmed to have a dynamic friction coefficient of 0.4 or less between the receptor layer surface of the image-receiving sheet before being coated with the protection layer and the outermost layer on the protection layer of the ink ribbon, is used; by use of the thermal-transfer printer, an area corresponding to a printing part of the ink ribbon is heated/pressed from the substrate side of the ink ribbon, using the thermal head, etc., to transfer the color material(s) in the color material layer to the receptor layer of the image-receiving sheet; then, the protection layer is transferred similarly, thereby obtaining a print.

### EXAMPLES

Hereinafter, the present invention will be described in detail, by way of examples and comparative examples. The scope of the present invention is not limited by these examples.

### Production Example 1

### Production of Ink Ribbon 1

A polyethylene terephthalate film having a thickness of 5 μm was used as the substrate. To one surface of the substrate, coating solutions 1 to 3 of the following compositions for color material layer and a coating solution 1 of the following composition for protection layer, were sequentially applied, followed by applying of a coating solution 1 for adhesive layer onto the applied protection layer and then drying, thereby producing the ink ribbon 1 containing color material layers and a protection layer, the color material layers and the protection layer having a total thickness of up to 3 μm when dried.

(Composition of the coating solution 1 for color material layer)

| | |
|---|---|
| Disperse dye (Disperse Yellow 231) | 2.0 parts by mass |
| Disperse dye (Yellow dye A represented by | 2.0 parts by mass |
| the following chemical formula (1)) | |
| Binder resin (Polyvinyl acetoacetal resin “KS-5” | 4.5 parts by mass |
| manufactured by Sekisui Chemical Co., Ltd.) | |
| Silicone oil (Methylstyryl-modified silicone oil | 0.5 part by mass |
| “KF410” manufactured by Shin-Etsu Chemical | |
| Co., Ltd.) | |
| Polyethylene wax (“T-10P-3” manufactured by Gifu | 3 parts by mass |
| Shellac Manufacturing Co., Ltd., solid content 10%) | |
| Methyl ethyl ketone | 44.0 parts by mass |
| Toluene | 44.0 parts by mass |

Chemical Formula (1)

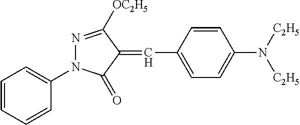 [SMILES: CCOC1=NN(c2ccccc2)C(=O)C1=Cc1ccc(N(CC)CC)cc1]

(Composition of the coating solution 2 for color material layer)

| | | |
|---|---|---|
| Disperse dye (MS Red G) | 2.0 | parts by mass |
| Disperse dye (Macrolex Red Violet R) | 2.0 | parts by mass |
| Binder resin (polyvinyl acetoacetal resin “KS-5” | 4.5 | parts by mass |
| manufactured by Sekisui Chemical Co., Ltd.) | | |
| Silicone oil (methylstyryl-modified silicone | 0.5 | part by mass |
| oil “KF410” manufactured by Shin-Etsu | | |
| Chemical Co., Ltd.) | | |
| Polyethylene wax (“T-10P-3” manufactured | 3 | parts by mass |
| by Gifu Shellac Manufacturing Co., Ltd., | | |
| solid content 10%) | | |
| Methyl ethyl ketone | 44.0 | parts by mass |
| Toluene | 44.0 | parts by mass |

(Composition of the coating solution 3 for color material layer)

| | | |
|---|---|---|
| Disperse dye (Solvent Blue 63) | 2.0 | parts by mass |
| Disperse dye (Disperse Blue 354) | 2.0 | parts by mass |
| Binder resin (polyvinyl acetoacetal resin “KS-5” | 4.5 | parts by mass |
| manufactured by Sekisui Chemical Co., Ltd.) | | |
| Silicone oil (methylstyryl-modified silicone | 0.5 | part by mass |
| oil “KF410” manufactured by Shin-Etsu | | |
| Chemical Co., Ltd.) | | |
| Polyethylene wax (“T-10P-3” manufactured | 3 | parts by mass |
| by Gifu Shellac Manufacturing Co., Ltd., | | |
| solid content 10%) | | |
| Methyl ethyl ketone | 44.0 | parts by mass |
| Toluene | 44.0 | parts by mass |

(Composition of the coating solution 1 for protection layer)

| | |
|---|---|
| Cellulose acetate propionate (“CAP504-0.2” | 70 parts by mass |
| manufactured by Eastman Chemical Company, | |
| number average molecular weight (Mn) 15,000) | |
| Cellulose acetate butyrate (“Solus 2100” | 30 parts by mass |
| manufactured by Eastman Chemical Company, | |
| number average molecular weight (Mn) 6,000) | |
| Methyl ethyl ketone/toluene (mass ratio 1:1) | 700 parts by mass |

(Composition of the coating solution 1 for adhesive layer)

| | |
|---|---|
| Vinyl chloride acetate resin (“SOLBIN C” | 25 parts by mass |
| manufactured by Nissin Chemical Industry Co., | |
| Ltd., number average molecular weight 31,000) | |
| Silica filler (“Sylysia 310” manufactured | 0.75 part by mass |
| by Fuji Silysia Chemical Ltd., average | |
| molecular diameter 3μ) | |
| Methyl ethyl ketone | 37.0 parts by mass |
| Toluene | 37.0 parts by mass |

### Production Example 2

### Production of Ink Ribbon 2

The ink ribbon 2 was produced in the same manner as Production Example 1, except that the amounts of the silicone oils used in the coating solutions 1 to 3 for color material layer were each changed to 1 part by mass, and the amounts of the polyethylene waxes used in the coating solutions 1 to 3 for color material layer were each changed to 7 parts by mass.

### Production Example 3

### Production of Ink Ribbon 3

The ink ribbon 3 was produced in the same manner as Production Example 1, except that the amounts of the silicone oils used in the coating solutions 1 to 3 for color material layer were each changed to 0.5 part by mass, and the amounts of the polyethylene waxes used in the coating solutions 1 to 3 for color material layer were each changed to 5 parts by mass.

### Production Example 4

### Production of Ink Ribbon 4

The ink ribbon 4 was produced in the same manner as Production Example 1, except that the silicone oils and polyethylene waxes of the coating solutions 1 to 3 for color material layer, were not used.

### Production Example 5

### Production of Image-Receiving Sheet 1

A coated paper (“Pealcoat N” manufactured by Mitsubishi Paper Mills Limited., 157.0 g/m²) was used as the substrate. To one surface of the substrate, a coating solution 1 of the following composition for image-receiving layer was applied and dried, thereby obtaining the image-receiving sheet 1 containing an image-receiving layer, the image-receiving layer having a thickness of 2 μm when dried.

(Composition of the coating solution 1 for image-receiving layer)

| | |
|---|---|
| Silicone oil (single terminal epoxy-modified silicone | 1 part by mass |
| oil “X-22-173DX” manufactured by Shin-Etsu | |
| Chemical Co., Ltd.) | |
| Vinyl chloride acetate resin (“SOLBIN C” | 20 parts by mass |
| manufactured by Nissin Chemical Industry Co., Ltd.) | |
| Methyl ethyl ketone | 40 parts by mass |
| Toluene | 40 parts by mass |

### Production Example 6

### Production of Image-Receiving Sheet 2

The image-receiving sheet 2 was obtained in the same manner as Production Example 5, except that the amount of the silicone oil used in the coating solution 1 for image-receiving layer was changed to 0.5 part by mass.

### Production Example 7

### Production of Image-Receiving Sheet 3

The image-receiving sheet 3 was obtained in the same manner as Production Example 5, except that the silicone oil of the coating solution 1 for image-receiving layer was not used.

### Test Example

### Measurement of Dynamic Friction Coefficient

The ink ribbons 1 to 4 were combined with the image-receiving sheets 1 to 3 as shown below and measured for dynamic friction coefficient.

In each case, the color material layers of the ink ribbon were printed all over the receptor layer of the image-receiving sheet, using a thermal-transfer printer, thereby obtaining the image-receiving sheet before being coated with the protection layer. The receptor layer surface of the thus-obtained image-receiving sheet before being coated with the protection layer, was brought into contact with the outermost surface (the adhesive layer surface) on the protection layer of the ink ribbon. After placing a 1 kg weight on the stack, the stack was placed in the environment of a temperature of 25° C. and a humidity of 50% and measured for the tension (g) when the ink ribbon was pulled so as to have an ink ribbon movement rate of 200 mm/min. Then, the dynamic friction coefficient was calculated from the value of the tension. A surface property tester (“TriboGear” (type: 14DR) manufactured by Shinto Scientific Co., Ltd.) was used to measure the tension. The results are shown in Table 1.

The dynamic friction coefficients of the combination of the ink ribbon 1 with the image-receiving sheet 1, the combination of the ink ribbon 2 with the image-receiving sheet 1, and the combination of the ink ribbon 3 with the image-receiving sheet 2 were 0.4 or less each. The dynamic friction coefficient of the combination of the ink ribbon 4 with the image-receiving sheet 3 was more than 0.4.

TABLE 1

| | | Content | | | | |
|---|---|---|---|---|---|---|
| | | (% by mass) | | | Content | Dynamic |
| | | Sili- | Poly- | Image- | (% by mass) | friction |
| | Ink | cone | ethylene | receiving | Silicone | coeffi- |
| | ribbon | oil | wax | sheet | oil | cient |
| Test | Ink | 0.5 | 0.3 | Image- | 5 | 0.35 |
| Example 1 | ribbon 1 | | | receiving | | |
| | | | | sheet 1 | | |
| Test | Ink | 1 | 0.7 | Image- | 5 | 0.30 |
| Example 2 | ribbon 2 | | | receiving | | |
| | | | | sheet 1 | | |
| Test | Ink | 0.5 | 0.5 | Image- | 0.5 | 0.40 |
| Example 3 | ribbon 3 | | | receiving | | |
| | | | | sheet 2 | | |
| Test | Ink | 0 | 0 | Image- | 0 | 0.45 |
| Example 4 | ribbon 4 | | | receiving | | |
| | | | | sheet 3 | | |

### Example

The ink ribbons were combined with the image-receiving sheets, according to the above-mentioned combinations of Test Examples 1 to 4, and prints were produced using the combinations. Measurements were carried out with a thermal-transfer printer “Photo Printer 6850” manufactured by Kodak, changing the protruding length of the tension member to 1 mm, 0.4 mm and 2 mm.

### [Evaluation of Prints]

Presence of printing unevenness of the thus-obtained prints was visually observed. Printing unevenness was not observed in any of the prints, which is due to large wrinkles in the ink ribbon edges. The results are shown in Table 2.

∘: Printing unevenness in the form of perforation was not observed near the center of the ink ribbon.

x: Printing unevenness in the form of perforation was observed near the center of the ink ribbon.

TABLE 2

| | | | | Protruding | |
|---|---|---|---|---|---|
| | | Image- | Dynamic | length of | |
| | Ink | receiving | friction | tension | Evaluation |
| | ribbon | sheet | coefficient | member | of print |
| Example 1 | 1 | 1 | 0.35 | 1.0 | ∘ |
| Example 2 | 1 | 1 | 0.35 | 0.4 | ∘ |
| Example 3 | 1 | 1 | 0.35 | 2.0 | ∘ |
| Example 4 | 2 | 1 | 0.30 | 1.0 | ∘ |
| Example 5 | 3 | 2 | 0.40 | 1.0 | ∘ |
| Comparative | 4 | 3 | 0.45 | 1.0 | x |
| Example 1 | | | | | |
| Comparative | 4 | 3 | 0.45 | 0.4 | x |
| Example 2 | | | | | |
| Comparative | 4 | 3 | 0.45 | 2.0 | x |
| Example 3 | | | | | |

From the results shown in Table 2, it is clear that the prints obtained by using the thermal-transfer printer equipped with the tension member having protruding lengths of 0.4 to 2 mm and obtained by the production methods of Examples 1 to 5, in each of which the ink ribbon was combined with the image-receiving sheet so that the dynamic friction coefficient between the receptor layer surface of the image-receiving sheet before being coated with the protection layer and the outermost surface on the protection layer of the ink ribbon was 0.4 or less, have no printing unevenness and are high-quality prints, therefore. On the other hand, it is clear that even in the case of using the same thermal-transfer printer, printing unevenness in the form of perforation was produced in Comparative Examples 1 to 3, in each of which the ink ribbon was combined with the image-receiving sheet so that the specific dynamic friction coefficient was 0.45.

### REFERENCE SIGNS LIST

1. Substrate
2, 2Y, 2M, 2Cy. Color material layer
3. Protection layer
10. Ink ribbon
20. Image-receiving sheet
30. Tension member
31. Ink ribbon facing surface
32. Edges in the width direction
33. Center
40. Thermal head
50. Platen roller
51. Printing position
52. Feeding direction
53. Ink ribbon winding direction
54. Direction of a tension applied to the ink ribbon in the printing position
55. Width direction
56. Flow direction of the ink ribbon
100. Thermal-transfer printer
L. Protruding length of the tension member

1. A method for producing a print, in which a print is made on an image-receiving sheet by use of a thermal-transfer printer and an ink ribbon, wherein,
the thermal-transfer printer comprises a tension member for tightly stretching the ink ribbon in the downstream of a printing position disposed between a thermal head and a platen roller;
the surface of the tension member facing the ink ribbon has a curved shape whose center in the width direction is protruding 0.4 to 2 mm in the flow direction of the ink ribbon, more than the edges in the width direction;
the ink ribbon has at least one color material layer and a protection layer;
the image-receiving sheet has a receptor layer; and
after printing all colors of the color material layers, the dynamic friction coefficient between the receptor layer surface of the image-receiving sheet before being coated with the protection layer and the outermost surface on the protection layer of the ink ribbon, is 0.4 or less.

2. The method for producing a print according to claim 1, wherein a silicone oil contained in the receptor layer accounts for 0.5 to 5.0% by mass of the total solid content of the receptor layer.

3. The method for producing a print according to claim 1, wherein a polyethylene wax contained in the color material layer of the ink ribbon accounts for 0.3 to 2.0% by mass of the total solid content of the color material layer.

4. The method for producing a print according to claim 2, wherein a polyethylene wax contained in the color material layer of the ink ribbon accounts for 0.3 to 2.0% by mass of the total solid content of the color material layer.
